(19) United States
(12) Patent Application Publication
(10) Pub. No.: US 2019/0304352 A1
(43) Pub. Date: Oct. 3, 2019

(54) COLOR TEMPERATURE ADJUSTING SYSTEM AND METHOD

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: CHUN-HSIEN CHO, New Taipei (TW)

(21) Appl. No.: 15/989,828

(22) Filed: May 25, 2018

(30) Foreign Application Priority Data
Apr. 3, 2018 (CN) 201810290108.7

(51) Int. Cl. G09G 3/20

(52) U.S. Cl. CPC G09G 3/2003; G09G 2320/0271; G09G 2320/0666

(57) ABSTRACT

A color temperature adjusting system includes a processing device, a color analyzing device or probe, and a monitor. The processing device communicates with the monitor and the color analyzing device. The color analyzing device obtains a color temperature value and a color coordinate value of the monitor, and transmits these read values to the processing device, which compares these values to standard ranges and tolerances. The processing device can send commands to the monitor to adjust RGB levels until the read values are within standard ranges.

### FIELD

The subject matter herein generally relates to colors in displays.

### BACKGROUND

In general, the user adjusts the color temperature of a display according to his or her perception and experience. If the adjusted value is incorrect, there may be a human-eye perception that the picture is slightly green.

### BRIEF DESCRIPTION OF THE DRAWINGS

Implementations of the present disclosure will now be described, by way of example only, with reference to the attached figures.

FIG. 1 is a block diagram of an exemplary embodiment of a color temperature adjusting system using a processing device.

FIG. 2 is a schematic diagram of the processing device of FIG. 1.

FIG. 3 and FIG. 4 are flow diagrams of an exemplary embodiment of a color temperature adjusting method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “comprising” means “including, but not necessarily limited to”; it specifically indicates open-ended inclusion or membership in a so-described combination, group, series, and the like.

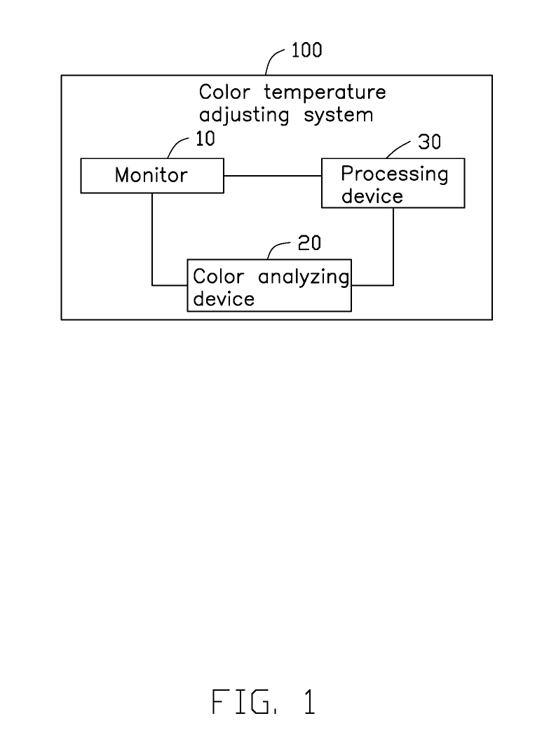

FIG. 1 illustrates a color temperature adjusting system 100 in accordance with an exemplary embodiment. In this exemplary embodiment, the color temperature adjusting system 100 includes a monitor 10, a color analyzing device 20, and a processing device 30.

In at least one exemplary embodiment, the color analyzing device 20 obtains a color temperature value and a color coordinate value of the monitor 10, and transmits the color temperature value and the color coordinate value to the processing device 30.

The color analyzing device 20 includes a sensor (not shown). The sensor extends to the center of the monitor 10 to obtain optical data. The color analyzing device 20 converts the optical data into the color temperature value and color coordinate value.

The processing device 30 communicates with the monitor 10 and the color analyzing device 20.

In at least one exemplary embodiment, the processing device 30 obtains the color temperature value and the color coordinate value. The processing device 30 also sends a command to adjust RGB values to the monitor 10. The processing device 30 adjusts the color temperature value of the monitor 10 within a standard range and the color coordinate value of the monitor 10 within the standard range.

In at least one exemplary embodiment, three primary colors are R, G, and B, where R is red, G is green, and B is blue.

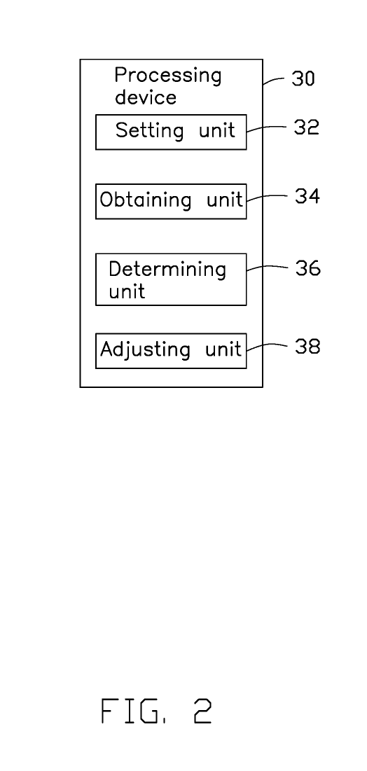

FIG. 2 illustrates that the processing device 30 includes a setting unit 32, an obtaining unit 34, a determining unit 36, and an adjusting unit 38.

The setting unit 32 defines a color temperature standard value and a color coordinate standard value.

The obtaining unit 34 obtains the color temperature value and the color coordinate value and transmits the color temperature value and the color coordinate value to the determining unit 36.

The determining unit 36 compares the color temperature value or reading with the color temperature standard value to obtain a first difference value, and determines whether the first difference value is within a first range.

For example, the setting unit 32 can set the color temperature standard value as 6500K, and the determining unit 36 can determine whether the acquired color temperature value or reading is between 6450K and 6550K. Thus, the first range may have a tolerance that cannot exceed positive and negative 50K.

The determining unit 36 compares the color coordinate value or reading with the color coordinate standard value to obtain a second difference value, and determines whether the second difference value is within the second range.

For example, the setting unit 32 can set the X coordinate value of the color coordinate standard value as 0.31 and the Y coordinate value as 0.33. The determining unit 36 determines whether the X coordinate value of the acquired color coordinate value is between 0.30 and 0.32 and whether the Y coordinate value of the acquired color coordinate value is between 0.32 and 0.34. Thus, the second range may have a tolerance that cannot exceed positive and negative 0.1.

When the first difference value is not within the first range, the determining unit 36 determines whether the first difference value is positive or negative.

If the first difference value is positive, the adjusting unit 38 controls the monitor 10 to reduce the B value until the first difference value is within the first range. The B value is the blue value in the three primary colors.

If the first difference value is negative, the adjusting unit 38 controls the monitor 10 to reduce the R value until the first difference value is within the first range. The R value is the red value in the three primary colors.

In at least one exemplary embodiment, the determining unit 36 also determines whether the second difference value is within the second range. If the second difference value is within the second range, the adjusting unit 38 does not need to make any adjustment to the monitor 10. If the second difference value is not within the second range, the determining unit 36 determines whether the second difference value is positive or negative.

If the second difference value is positive, the adjusting unit 38 controls the monitor 10 to reduce the G value until the second difference value is within the second range. The G value is the green value in the three primary colors.

If the second difference value is negative, the adjusting unit 38 controls the monitor 10 to reduce the B value, the determining unit 36 then determines whether the first difference value and the second difference value are within their respective ranges. If the first difference value is not within the first range, the adjusting unit 38 controls the monitor 10 to reduce the R value until the first difference value is within the first range.

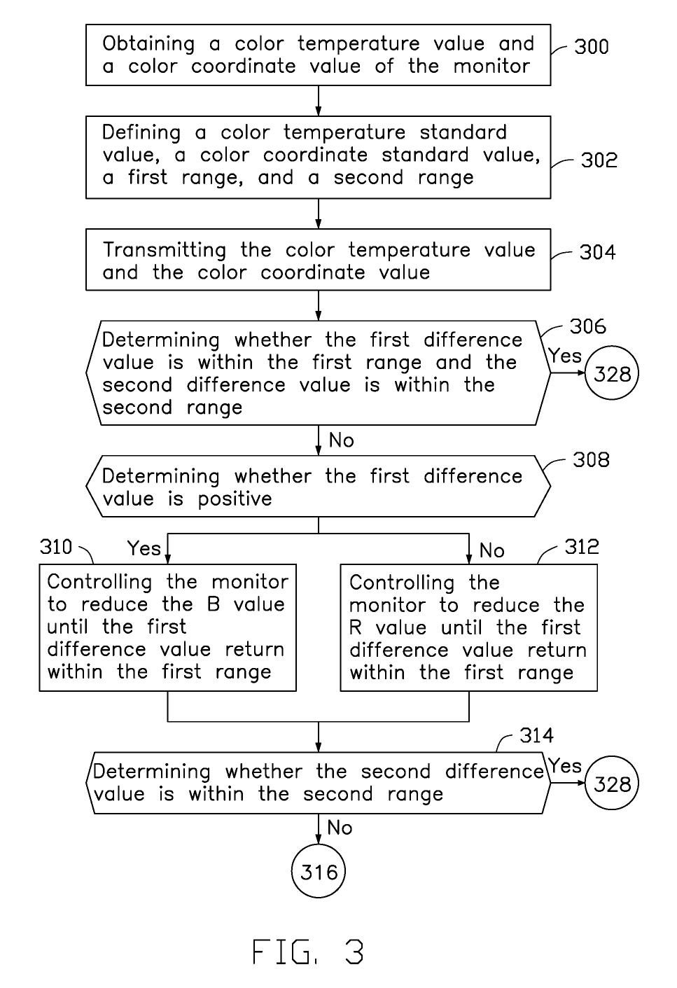

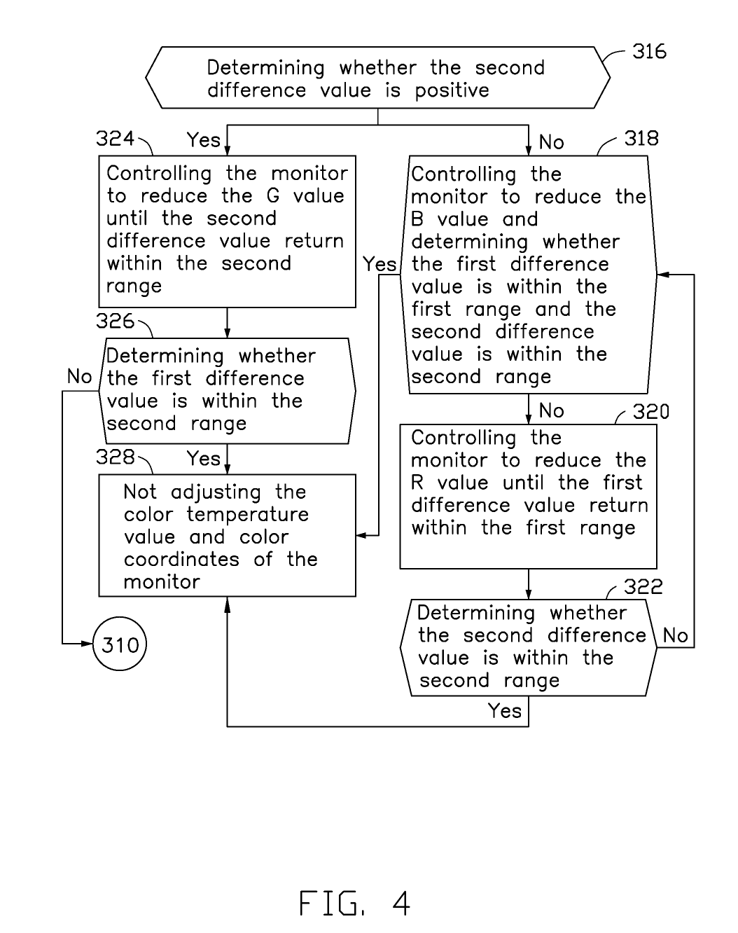

FIG. 3 and FIG. 4 are a flowchart depicting an exemplary embodiment of a color temperature adjusting method. The method is provided by way of example, as there are a variety of ways to carry out the method. The exemplary method described below can be carried out using the configurations illustrated in FIGS. 1-2, for example, and various elements of these figures are referenced in explaining the example method. Each block shown in FIG. 3 and FIG. 4 represents one or more processes, methods, or subroutines, carried out in the example method. Furthermore, the illustrated order of blocks is illustrative only and the order of the blocks can change. Additional blocks can be added or fewer blocks may be utilized, without departing from the present disclosure. The example method can begin at block 300.

At block 300, the color analyzing device 20 obtains a color temperature value and a color coordinate value of the monitor 10.

In at least one exemplary embodiment, the color analyzing device 20 includes a sensor (not shown). The sensor extends to the center of the monitor 10 to obtain the optical data. The color analyzing device 20 converts the optical data into the color temperature value and color coordinate value.

At block 302, the setting unit 32 defines a color temperature standard value, a color coordinate standard value, a first range, and a second range.

In at least one exemplary embodiment, the determining unit 36 compares a reading of the color temperature value with the color temperature standard value to obtain a first difference value, and determines whether the first difference value is within the first range. The first range is a preset range under the specification standard.

For example, the setting unit 32 sets the color temperature standard value at 6500K, and the determining unit 36 determines whether the acquired color temperature value is between 6450K and 6550K. Thus, the first range allows for positive and negative tolerances not exceeding 50K.

In at least one exemplary embodiment, the determining unit 36 compares a reading of the color coordinate value with the color coordinate standard value to obtain a second difference value, and determines whether the second difference value is within the second range.

For example, the setting unit 32 can set the X coordinate value of the color coordinate standard value as 0.31 and the Y coordinate value as 0.33. The determining unit 36 determines whether the acquired color coordinate value of the X coordinate is between 0.30 and 0.32 and whether the acquired color coordinate value of the Y coordinate is between 0.32 and 0.34. Thus, the second range allows for positive and negative tolerances not exceeding 0.1.

At block 304, the color analyzing device 20 transmits the color temperature value and the color coordinate value of the monitor 10 to the determining unit 36.

At block 306, the determining unit 36 determines whether the first difference value is within the first range and whether the second difference value is within the second range. If the first difference value is within the first range and the second difference value is within the second range, block 328 is implemented, otherwise the block 308 is implemented.

At block 308, the determining unit 36 determines whether the first difference value is positive or negative. If the first difference value is positive, block 310 is implemented, otherwise the block 312 is implemented.

At block 310, the adjusting unit 38 controls the monitor 10 to reduce the B value until the first difference value is within the first range. The B value is the blue value in the three primary colors.

At block 312, the adjusting unit 38 controls the monitor 10 to reduce the R value until the first difference value is within the first range. The R value is the red value in the three primary colors.

At block 314, the determining unit 36 determines whether the second difference value is within the second range. If the second difference value is within the second range, block 328 is implemented, otherwise block 316 is implemented.

At block 316, the determining unit 36 determines whether the second difference value is positive. If the second difference value is positive, block 324 is implemented, otherwise the block 318 is implemented.

At block 318, the adjusting unit 38 controls the monitor 10 to reduce the B value, and the determining unit 36 determines whether the first difference value is within the first range and the second difference value is within the second range. If the first difference value is within the first range and the second difference value is within the second range, block 328 is implemented, otherwise the block 320 is implemented.

At block 320, the adjusting unit 38 controls the monitor 10 to reduce the R value until the first difference value is within the first range.

At block 322, the determining unit 36 determines whether the second difference value is within the second range. If the second difference value is within the second range, block 328 is implemented, otherwise the procedure returns to the block 318.

At block 324, the adjusting unit 38 controls the monitor 10 to reduce the G value until the second difference value is within the second range. The G value is the green value in the three primary colors.

At block 326, the determining unit 36 determines whether the first difference value is within the first range. If the first difference value is within the first range, block 328 is implemented, otherwise the procedure returns to the block 310.

At block 328, the adjusting unit 38 does not adjust the color temperature value and color coordinates of the monitor 10.

The exemplary embodiments shown and described above are only examples. Many details are often found in the art such as the other features of color displays. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A color temperature adjusting method comprising:
obtaining a color temperature value and a color coordinate value of a monitor;
comparing the color temperature value with a color temperature standard value to obtain a first difference value;
comparing the color coordinate value with a color coordinate standard value to obtain a second difference value;
determining whether the first difference value is within a first range and the second difference value is within a second range;
adjusting the color temperature value until the first difference value return within the first range when the first difference value is not within the first range; and
adjusting the color coordinate value until the second difference value return within the second range when the second difference value is not within the second range.

2. The color temperature adjusting method of claim 1, wherein further comprising:
determining whether the first difference value is positive when the first difference value is not within the first range; and
controlling the monitor to reduce a B value until the first difference value is within the first range when the first difference value is positive, wherein the B value is blue value in three primary colors.

3. The color temperature adjusting method of claim 2, wherein further comprising:
controlling the monitor to reduce a R value until the first difference value is within the first range when the first difference value is negative, wherein the R value is red value in three primary colors.

4. The color temperature adjusting method of claim 3, wherein further comprising:
determining whether the second difference value is within the second range;
determining whether the second difference value is positive when the second difference value is not within the second range; and
controlling the monitor to reduce a G value until the second difference value is within the second range when the second difference value is positive, wherein the G value is green value in three primary colors.

5. The color temperature adjusting method of claim 4, wherein further comprising:
controlling the monitor to reduce the B value when the second difference value is negative; and
determining whether the first difference value is within the first range and the second difference value is within the second range.

6. The color temperature adjusting method of claim 5, wherein further comprising:
controlling the monitor to reduce the R value until the first difference value is within the first range when the first difference value is not within the first range and the second difference value is not within the second range.

7. A color temperature adjusting system, comprising:
a color analyzing device obtaining a color temperature value and a color coordinate value of a monitor;
a determining unit comparing the color temperature value with a color temperature standard value to obtain a first difference value; the determining unit comparing the color coordinate value with a color coordinate standard value to obtain a second difference value; the determining unit determining whether the first difference value is within a first range and the second difference value is within a second range; and
an adjusting unit adjusting the color temperature value until the first difference value is within the first range when the first difference value is not within the first range;
wherein the adjusting unit adjusts the color coordinate value until the second difference value is within the second range when the second difference value is not within the second range.

8. The color temperature adjusting system of claim 7, wherein when the first difference value is not within the first range, the determining unit determines whether the first difference value is positive; the adjusting unit controls monitor to reduce the B value until the first difference value is within the first range when the first difference value is positive; the adjusting unit controls monitor to reduce the R value until the first difference value is within the first range when the first difference value is negative.

9. The color temperature adjusting system of claim 8, wherein when the second difference value is not within the second range, the determining unit determines whether the second difference value is positive, and the adjusting unit controls monitor to reduce the G value until the second difference value is within the second range when the second difference value is positive.

10. The color temperature adjusting system of claim 9, wherein the adjusting unit controls monitor to reduce the B value when the second difference value is negative.

11. The color temperature adjusting system of claim 10, wherein the determining unit determines whether the first difference value is within the first range and the second difference value is within the second range; the adjusting unit controls the monitor to reduce the R value until the first difference value is within the first range when the first difference value is not within the first range and the second difference value is not within the second range.

12. A color temperature adjusting system, comprising:
a color analyzing device obtaining a color temperature value and a color coordinate value of a monitor;
a determining unit comparing the color temperature value with a color temperature standard value to obtain a first difference value; the determining unit comparing the color coordinate value with a color coordinate standard value to obtain a second difference value; the determining unit determining whether the first difference value is within a first range and the second difference value is within a second range;
an adjusting unit adjusting the color temperature value until the first difference value is within the first range when the first difference value is not within the first range; the adjusting unit adjusting the color coordinate value until the second difference value is within the second range when the second difference value is not within the second range;
wherein when the first difference value is not within the first range, the determining unit determines whether the first difference value is positive; the adjusting unit controls monitor to reduce a B value until the first difference value is within the first range when the first difference value is positive; the adjusting unit controls monitor to reduce a R value until the first difference value is within the first range when the first difference value is negative; wherein the B value is blue value in three primary colors; and wherein the R value is red value in three primary colors.

13. The color temperature adjusting system of claim 12, wherein when the second difference value is not within the second range, the determining unit determines whether the second difference value is positive, and the adjusting unit controls monitor to reduce a G value until the second difference value is within the second range when the second difference value is positive; wherein the G value is green value in three primary colors.

14. The color temperature adjusting system of claim 13, wherein the adjusting unit controls monitor to reduce the B value when the second difference value is negative.

15. The color temperature adjusting system of claim 14, wherein the determining unit determines whether the first difference value is within the first range and the second difference value is within the second range; the adjusting unit controls the monitor to reduce the R value until the first difference value is within the first range when the first difference value is not within the first range and the second difference value is not within the second range.
